(19) United States
(12) Patent Application Publication
(10) Pub. No.: US 2018/0305609 A1
(43) Pub. Date: Oct. 25, 2018

(54) ENCAPSULATED ADDITIVES FOR USE IN SUBTERRANEAN FORMATION OPERATIONS

(71) Applicant: Halliburton Energy Services, Inc., Houston, TX (US)

(72) Inventors: Lee J. HALL, The Woodlands, TX (US); Sandip AGARWAL, Arlington, MA (US); Brian MAYERS, Arlington, MA (US); Olivier SCHUELLER, Arlington, MA (US); Hootan FARHAT, Somerville, MA (US); Phil GRAF, Chestnut Hill, MA (US); Joseph MCLELLAN, Quincy, MA (US)

(21) Appl. No.: 15/768,513

(22) PCT Filed: Jan. 22, 2016
(86) PCT No.: PCT/US2016/014485

§ 371 Date: Apr. 13, 2018

(51) Int. Cl. C09K 8/70; C09K 8/92; C09K 8/80

(52) U.S. Cl. CPC C09K 8/706; C09K 8/92; C09K 8/80; C09K 2208/20; C09K 8/605; C09K 2208/28; C09K 2208/32; C09K 2208/34; C09K 2208/26

(57) ABSTRACT

Compositions, methods, and systems including an encapsulated additive comprising a treatment fluid additive at least partially encapsulated by an encapsulating material. The encapsulated additive has a target release profile for release of the treatment fluid additive from the encapsulating material in a specific wellbore environment. The encapsulating material is selected to achieve the target release profile, the target release profile being based on one or more conditions selected from the group consisting of: (1) a target anisotropic pressure that is greater than both an injection anisotropic pressure and an injection isotropic pressure, (2) an erosion number, (3) a temperature-driven degradation, (4) a pressure-driven degradation, (5) an amphiphilic water dispersibility, (6) an amphiphilic oil dispersibility, (7) a chemical flood degradation, (8) a water ingress value, and, (9) a radiation-driven degradation.

### BACKGROUND

The present disclosure relates to subterranean formation operations and, more particularly, to encapsulated additives for use in subterranean formation operations.

Hydrocarbon producing wells (e.g., oil producing wells, gas producing wells, and the like) are created and stimulated using various treatment fluids introduced into the wells to perform a number of subterranean formation operations. The general term “treatment fluid,” as used herein, refers generally to any fluid that may be used in a subterranean application in conjunction with a desired function and/or for a desired purpose. The term “treatment fluid” does not imply any particular action by the fluid or any component thereof.

Hydrocarbon producing wells are first formed by drilling a wellbore into a subterranean formation, involving circulating a drilling treatment fluid as the wellbore is bored out using a drill bit. Primary cementing may then be performed using a cement slurry treatment fluid to enhance the structural integrity of the wellbore. Stimulation of hydrocarbon producing wells often involves introducing a fracturing treatment fluid, sometimes called a carrier treatment fluid when particulates are entrained therein. The fracturing treatment fluid is pumped into a portion of a subterranean formation (which may also be referred to herein simply as a “formation”) above a fracture gradient sufficient to break down the formation and create or enhance one or more fractures therein. As used herein, the term “fracture gradient” refers to a pressure (e.g., flow rate) necessary to create or enhance at least one fracture in a subterranean formation.

Typically, particulate solids are suspended in a portion of one or more treatment fluids and then deposited into the fractures. The particulate solids, known as “proppant particulates” or simply “proppant” serve to prevent the fractures from fully closing once the hydraulic pressure is removed. By keeping the fractures from fully closing, the proppant particulates form a proppant pack having interstitial spaces that act as conductive paths through which fluids produced from the formation may flow. As used herein, the term “proppant pack” refers to a collection of proppant particulates in a fracture, thereby forming a “propped fracture.”

During the creation and stimulation of such hydrocarbon producing wells, the treatment fluids used typically comprise one or more additives designed to enhance the performance of the particular operation in which the treatment fluid is being used, or to glean information about the formation in which the wellbore is created. These additives are reactive under a variety of conditions in a wellbore environment, which may be present at different locations within the wellbore (e.g., uphole, downhole, and the like), under different conditions within the wellbore (e.g., contact with secondary treatment fluids, exposure to certain forces, chemistry, or heat, and the like), and the like.

### BRIEF DESCRIPTION OF THE DRAWINGS

The following figures are included to illustrate certain aspects of the embodiments herein, and should not be viewed as exclusive embodiments. The subject matter disclosed is capable of considerable modifications, alterations, combinations, and equivalents in form and function, as will occur to those skilled in the art and having the benefit of this disclosure.

FIGS. 1A-1B are scanning electron microscope images of an encapsulated additive that is formed using a molecular sieve, according to one or more embodiments of the present disclosure.

FIG. 2 depicts a graph showing a correlation between the thickness of an encapsulating material of an encapsulated additive and pressures experienced in a wellbore environment, according to one or more embodiments of the present disclosure.

FIGS. 3A-3B illustrate an example of the pressures that would be experienced by a spherical encapsulated additive in a wellbore environment, according to one or more embodiments of the present disclosure.

FIGS. 4A-4B illustrate an example of the pressures that would be experienced by a spherical encapsulated additive in a wellbore environment, according to one or more embodiments of the present disclosure.

FIGS. 5A-5B are scanning electron microscope images of a spherical encapsulated additive experiencing anisotropic pressure, according to one or more embodiments of the present disclosure.

FIG. 6 is a scanning electron microscope image of an encapsulated additive that is substantially free of defects, according to one or more embodiments of the present disclosure.

FIG. 7 depicts a graph showing water ingress values for certain encapsulating materials, according to one or more embodiments of the present disclosure.

FIG. 8 is a scanning electron microscope image of an encapsulated additive that comprises micro-crack defects, according to one or more embodiments of the present disclosure.

FIG. 9 illustrates a system that can deliver the encapsulated additives described herein to a downhole location, according to one or more embodiments of the present disclosure.

### DETAILED DESCRIPTION

The present disclosure relates to subterranean formation operations and, more particularly, to encapsulated additives for use in subterranean formation operations.

The embodiments described herein relate to encapsulated additives comprising a treatment fluid additive encapsulated by an encapsulating material. The encapsulated additives of the present disclosure, formed from the treatment fluid additive(s) and encapsulating material(s) described herein, can reduce operational costs associated with performing subterranean formation operations. Such operational cost reduction using the encapsulated additives of the present disclosure may be realized by improving worker safety, improving targeted placement of treatment fluid additives (and their associated chemistry) in a wellbore environment, enabling new forms of treatments during subterranean formation operations, and the like, and any combination thereof.

As used herein, the term “treatment fluid additive,” and grammatical variants thereof, refers to any substance that may be used for a subterranean application in conjunction with a desired function and/or for a desired purpose within a treatment fluid. As used herein, the term “encapsulating material” refers to any substance that is able to coat the surface of all or a portion of one or more treatment fluid additives to allow targeted placement and reaction of the treatment fluid additive in a wellbore environment. The term “wellbore environment,” and grammatical variants thereof, as used herein, refers to any subsurface location within a wellbore extending from a surface location, including cracks, natural or induced fractures, reservoirs, and other areas in fluid connection (i.e., the ability for fluid to flow therebetween) with the wellbore. Such wellbores may be vertical, horizontal, otherwise deviated wholly or partially, or be multilaterally completed, without departing from the scope of the present disclosure.

While the present disclosure focuses on particular treatment fluids additives as examples for formulating and optimizing the encapsulated additives described herein for use in particular subterranean formations and particular formation operations for targeting release including an explosive particulate, a lubricant, a biocide, a hydrogen sulfide scavenger, a breaker, a proppant, an oxygen scavenger, it is to be appreciated that other treatment fluids additives may also be used to form the encapsulated additives described herein, without departing from the scope of the present disclosure. Examples of such treatment fluids additives include, but are not limited to, a salt, a weighting agent, an inert solid, a fluid loss control agent, an emulsifier, a dispersion aid, a corrosion inhibitor, an emulsion thinner, an emulsion thickener, a viscosifying agent, a gelling agent, a surfactant, a particulate, a proppant, a gravel particulate, a consolidating resin, a conformance gel, a lost circulation material, a foaming agent, a gas, a pH control additive, a crosslinker, a stabilizer, a chelating agent, a scale inhibitor, a gas hydrate inhibitor, a mutual solvent, an oxidizer, a reducer, a friction reducer, a clay stabilizing agent, and any combination thereof.

Moreover, while the present disclosure focuses on subterranean formation operations, it is to be appreciated that the encapsulated additives described herein may be used for target release of a treatment fluid additive upon encountering a target release profile in any other industry, without departing from the scope of the present disclosure. For example, the encapsulated additives described herein may be suitable for use in such diverse fields including, but not limited to, the automotive industry, aerospace, the mining industry, pipeline applications, agricultural applications and products (e.g., for delivering pesticides or other products to agricultural fields), and the like, and any combination thereof.

The embodiments herein utilize optimized, novel encapsulating materials (e.g., polymeric or glassy coatings) to at least partially encapsulate a treatment fluid additive for use in a subterranean formation. As used herein, the term “at least partially encapsulate,” and grammatical variants thereof (e.g., “at least partially encapsulating,” “at least partially encapsulated,” and the like), refers to at least about 50% of the outer surface of one or more treatment fluid additives being surrounded by the encapsulating material. The term “surrounded” does not imply contact. For example, the encapsulating material can be highly porous where a smaller amount of material is actually in contact with the treatment fluid additives, depending on, for example, pore shape, pore size, density, and the like. The terms “at least partially encapsulate” and “at least partially coat,” and grammatical variants thereof, are used interchangeably herein, unless otherwise specifically indicated. That is, a single treatment fluid additive (e.g., a single explosive particulate) may be at least partially (or wholly) encapsulated by an encapsulating material, or multiple treatment fluid additives (e.g., a plurality of explosive particulates) may be at least partially (or wholly) encapsulated by an encapsulating material, without departing from the scope of the present disclosure.

When multiple treatment fluid additives are encapsulated together, they may be agglomerated together by a binder. The binder serves as an adhesive for agglomerating the various treatment fluid additives together, which can be in solid form or liquid form, as discussed in greater detail below. Suitable binders for agglomerating a plurality of treatment fluid additives for at least partial encapsulation with an encapsulating agent(s) include, but are not limited to, a non-aqueous tackifying agent, an aqueous tackifying agent, a silyl-modified polyamide compound, a curable resin (e.g., an epoxy resin), a crosslinkable aqueous polymer composition, a polymerizable organic monomer composition, a zeta potential-modifying aggregating composition, a silicon-based resin, a consolidation agent emulsion, a cement, asphalt, and any combination thereof.

Each of the encapsulated additives of the present disclosure has a target release profile in a wellbore environment. As used herein, the term “target release profile,” and grammatical variants thereof, refers to the release of a treatment fluid additive from an encapsulating material in a specific wellbore environment. Examples of conditions in which the target release profiles of the encapsulated additives described herein release the treatment fluid additive in a specific wellbore environment include, but are not limited to, a target anisotropic pressure that is greater both than the injection anisotropic pressure and the injection isotropic pressure, an erosion number, a temperature-driven degradation, a pressure-driven degradation, an amphiphilic water dispersibility, an amphiphilic oil dispersibility, a chemical flood degradation, a water ingress value, and a radiation-driven degradation. Combinations of these target release profiles are also possible, without departing from the scope of the present disclosure, depending on the composition of the encapsulated additive.

As used herein, the term “anisotropic pressure,” and grammatical variants thereof, refers to directionally dependent pressure; and “isotropic pressure,” and grammatical variants thereof, refers to directionally uniform (in all orientation) pressure. The terms “injection anisotropic pressure” and “injection isotropic pressure,” and grammatical variants thereof, refers herein to the anisotropic or isotropic pressure, respectively, at which a treatment fluid is injected into a subterranean formation (i.e., a wellbore) without causing a breakdown, or fracture, of the formation. That is, it is the injection anisotropic and isotropic pressures that are below the fracture gradient pressure. As used herein, the term “target anisotropic pressure,” and grammatical variants thereof, refers to an anisotropic pressure that is greater than both the injection anisotropic and isotropic pressures, and is a pressure selected to release a particular encapsulated additive. The term “erosion number,” and grammatical variants thereof, as used herein, is represented by the symbol “ε” and refers to the ratio between diffusion time of a fluid, such as water, within a material (e.g., the encapsulating material) and degradation time of the material. The erosion number is dimensionless and may include either or both of surface erosion (i.e., degradation from the exterior surface of a material) or bulk erosion (i.e., degradation of the entirety of the material equally), where an erosion number that decreases away from one (1) (where ε<<1) indicates increased bulk erosion domination and where an erosion that increases away from one (1) (where ε>>1) indicates increased surface erosion domination.

As used herein, the terms “temperature-driven degradation,” “pressure-driven degradation,” “radiation-driven degradation,” and “chemical flood degradation,” and grammatical variants thereof, refer to the conversion of a material into smaller components, intermediate, or end products by thermal reaction, a pressure induced reaction (e.g., frangibility), a radiation induced reaction, or a chemical reaction due to contact with a reactant chemical, respectively. The terms “amphiphilic water dispersibility” and “amphiphilic oil dispersibility,” and grammatical variants thereof, refers herein to the separation (e.g., by solubility) of portions (e.g., particles) of a material in contact with water or oil, respectively. For example, amphiphilic water or oil dispersibility may result in removal of an encapsulating material by forming colloid or suspensions with particles or portions of the encapsulating material, thereby removing those particles or portions from the encapsulated additive and allowing all or some of the treatment fluid additive to be released into a wellbore environment. As used herein, the term “water ingress value,” and grammatical variants thereof, refers to a flux defined as the rate of fluid passing from the outside of an encapsulating material to the interior per unit area of the encapsulating material.

It is to be appreciated that the rate of release of the treatment fluid additive from the encapsulating material of an encapsulated additive varies based on the target release profile, as well as the type, composition, and amount (e.g., concentration of treatment fluid additive and/or encapsulating material, amount of surface area coated of the treatment fluid additive(s), and the like). Accordingly, in some embodiments, the encapsulating material may break away immediately upon encountering the target release profile, thereby releasing the entirety of the treatment fluid additive into the wellbore environment. In other embodiments, the encapsulating material may degrade slowly or allow diffusion of the treatment fluid additive therethrough, in which case the treatment fluid is not released entirely at once but in some lesser amount over time.

The encapsulated additives described herein is designed based on a desired target release profile expected to be encountered in a particular wellbore environment, taking into account the desired treatment fluid additive(s) and compatible encapsulating material(s), as described in several detailed examples below. The encapsulated additive is introduced into a subterranean formation where the target release profile is encountered in the wellbore environment and the treatment fluid additive is released from the encapsulating material. The released treatment fluid additive or a portion thereof (e.g., when it does not release in its entirety at once) performs a specific treatment operation.

As discussed above, some treatment fluid additives include, but are not limited to, an explosive particulate, a lubricant, a biocide, a hydrogen sulfide scavenger, a breaker, a proppant, an oxygen scavenger, and any combination thereof, among other treatment fluid additives described herein. The treatment fluid additives may be in solid or liquid phase form. As used herein, the term “solid phase form” or simply “solid form,” and grammatical variants thereof, refers to a material that is not free-flowing, whereas the term “liquid phase form” or simply “liquid form,” and grammatical variants thereof, refers to a material that is free-flowing. For example, the proppant is in solid form, but the term remaining treatment fluid additives may be in either solid form or liquid form. When in solid form, the treatment fluid additives have an outer surface that is at least partially encapsulated with the encapsulating material. When in liquid form, the treatment fluid additive may be formed into a droplet that can be at least partially encapsulated with the encapsulating material, such as by aerosolizing the liquid to prepare it for coating.

In some embodiments, the size of the solid form treatment fluid additive is in the range of a unit mesh size of about 0.001 micrometer (μm) to about 5000 μm, encompassing any value and subset therebetween. In other embodiments, the size of the solid form treatment fluid additive is in the range of a unit mesh size of about 0.1 μm to about 5000 μm, or about 1 μm to about 500 μm, or about 1 μm to about 50 μm, or about 1 μm to about 10 μm, encompassing any value and subset therebetween. As used herein, the term “unit mesh size” refers to a size of an object (e.g., a particulate) that is able to pass through a square area having each side thereof equal to a specified numerical value.

The method for at least partially or wholly encapsulating a treatment fluid additive may be by any means suitable for forming the coating with the encapsulating material about the one or more treatment fluid additives. A preferred method of encapsulation for the embodiments of the present disclosure is spray coating the encapsulating material about an outer surface of the treatment fluid additive. For example, the spray coating method may be a Wurster process, which employs a fluidized bed process for spray coating. More specifically, solid particles are moved with a fluidizing air stream inducing cyclic particle flow upward past a spray nozzle, which sprays atomized droplets of the encapsulating material concurrently with the particle flow.

In some preferred embodiments, when the treatment fluid additive is in liquid form, the encapsulated additives described herein are formed by adsorbing the liquid treatment fluid additive onto or into a surface of a high surface area particle, and thereafter at least partially encapsulating the high surface area particle having the treatment fluid additive adsorbed thereon or therein with an encapsulating material. As used herein, the term “high surface area particle,” and grammatical variants thereof, refers to a solid particle having a total surface area per unit mass of about 0.02 square meters per gram (m²/g) to about 7000 m²/g, encompassing any value and subset therebetween. In other embodiments, the high surface area particles may have a total surface area per unit mass of about 150 m²/g to about 4000 m²/g, encompassing any value and subset therebetween. As a specific example, the high surface area particle may be activated carbon and have a total surface area per unit mass of about 3000 m²/g to about 4000 m²/g, encompassing any value and subset therebetween. Accordingly, the high surface area particle can be in a solid form, but can be porous to increase its surface area, where the porosity can be void space that encroaches into an interior area of the particle partially or wholly such that fluid flow can occur through the high surface area particle, without departing from the scope of the present disclosure.

In some embodiments, the high surface area particles for adsorption of the treatment fluid additive may be a molecular sieve. As used herein, the term “molecular sieve,” and grammatical variants thereof, refers to a material with macro-, meso-, or micro-pores of uniform size. The molecular sieve is further of an adequate size for adsorption and release of the treatment fluid additive. As used herein, a macro-porous molecular sieve comprises pores with a unit mesh size of greater than 50 nanometers (nm), a meso-porous molecular sieve comprises pores with unit mesh sizes between 2 nm to 50 nm, and a micro-porous molecular sieve comprises pores with a unit mesh size of less than 2 nm. Suitable materials for the high surface area particles include, but are not limited to zeolite materials, silicate materials (i.e., porous glass, silica, aluminosilicate materials), carbon materials (i.e., carbon black, activated carbon), clay materials (i.e., montmorillonite clay, halloysite clay), metal phosphates (e.g., aluminum phosphate, silico-alumino-phosphate), metal nitrides, metal sulfides, and the like, and any combination thereof. Although the high surface area particles described above refer to molecular sieves, it will be appreciated that other porous high surface area particles may be used in accordance with the embodiments of the present disclosure, including those with highly non-uniform sized pores, without departing from the scope of the present disclosure. For example, any of the materials used above for the molecular sieves may additionally have highly non-uniform pores and be used as a high surface area particle, as well as other materials including, but not limited to, cellulose nanofibrils, cellulose nanocrystals, metal-organic-frameworks, cyclodextrins (powder compressed into a pellet resulting in a high surface area particle), polyoxometalates, aerogels, diatomaceous earth, and the like, and any combination thereof.

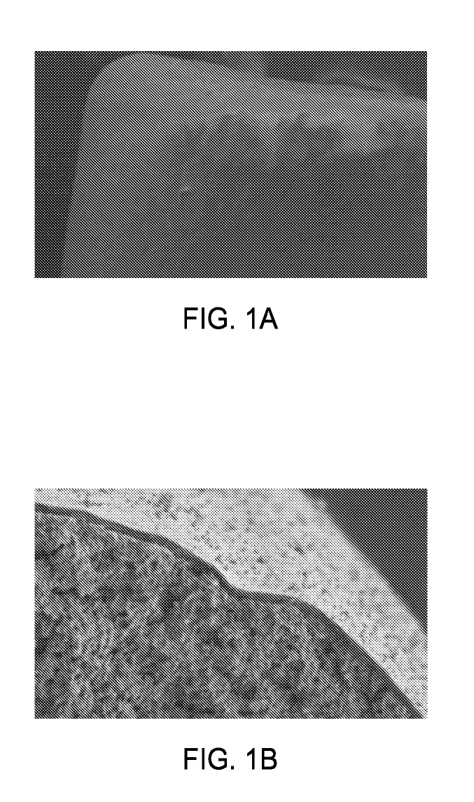

The pore size of the high surface area particles, including those of uniform (molecular sieves) and non-uniform sizes, may be any pore size that meets the required high surface area particle SA:V described herein. In some embodiments, the pore size of the high surface area particles is in the range of about 0.3 nm to about 500 nm, encompassing any value and subset therebetween. Additionally, the size of the high surface area particles may be any size suitable for use in a subterranean formation and capable of adsorbing an effective amount of treatment fluid additive for performing a particular subterranean formation operation. As a specific example, as shown in FIG. 1A, illustrated is a scanning electron microscope (SEM) image of a 1.6 mm×3 mm molecular sieve encapsulated in cellulose acetate butyrate. In FIG. 1B is an SEM of the molecular sieve where the porosity of the molecular sieve and the encapsulating material coating can be seen.

The encapsulating materials for use in at least partially encapsulating the treatment fluid additives of the present disclosure include any material capable of releasing the treatment fluid additives described herein upon encountering a target release profile, such as within a subterranean formation. Moreover, the selection of the encapsulating material depends on the desired target release profile conditions (e.g., based on wellbore environmental conditions) and also the type of treatment fluid additive selected. For example, in some instances, as discussed in greater detail below, the treatment fluid additive is reactive when in contact with water, such as to accelerate degradation or removal of the encapsulating material or to transform the treatment fluid additive into a reactive form for performing a subterranean formation operation, or both. In such cases, it may be preferred that the encapsulating material has a target release profile based on a water ingress value specific for the treatment fluid additive.

In some embodiments, the material selected for forming the encapsulating material includes, but is not limited to, a polyester, a polyanhydride, a polyamide, a polyketal, a polyphosphazene, a poly(anhydride ester), a polyacrylic acid, a polyacrylate, a polyacrylic acid-polyacrylate copolymer, and any combination thereof. Examples of specific materials for forming the encapsulating material include, but are not limited to, cellulose acetate butyrate, cellulose acetate, poly(isobutylmethacrylate), poly(bis-ethoxyphosphazene), polystyrene, poly(methyl methacrylate), polycaprolactone, polyvinylacetate, polyethylene, polyethyleneimine, polyethylene glycol, polyethyleneimine-polyethylene glycol co-polymer, polyvinyl alcohol, polyvinyl acetate, ethyl cellulose, nitro cellulose, polystyrene, polystyrene-butadiene-styrene co-polymers, Polystyrene-butadiene rubbers, polydimethylsiloxanes, silicone rubbers, polyurethane, polyurea, epoxy, silica, titania, guar gum, and any combination thereof.

Generally, the thickness of the encapsulating material at least partially encapsulating the treatment fluid additive(s) can be used to alter the degradation, dispersibility, erosion, or an otherwise compromising characteristic of the encapsulating material to achieve a desired target release profile. For example, a thicker encapsulating material coating can slow the release of the treatment fluid additive (e.g., because more of the encapsulating material must be degraded, dispersed, or eroded, and the like), whereas the opposite would be true of a thinner encapsulating material thickness. Additionally, the same holds true for encapsulating material that crack or are frangible under pressure, where a thicker encapsulating material would typically require increased pressure to crack and a thinner encapsulating material would typically require less pressure to crack, depending on the particular encapsulating material and treatment fluid additive selected.

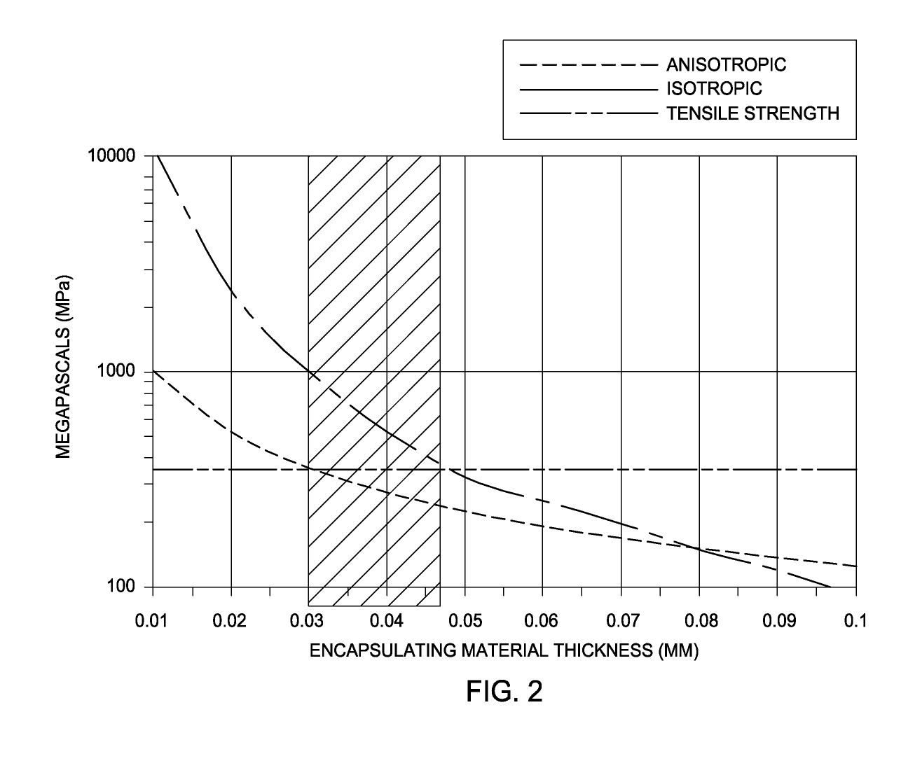

Referring now to FIG. 2, illustrated is a graph depicting a correlation between the thickness of an encapsulating material of an encapsulated additive and pressures experienced in a wellbore environment. Specifically, the pressures shown are anisotropic pressure, isotropic pressure, and tensile strength, each expressed in megapascals (MPa), and the encapsulating material thickness is expressed in millimeters (mm). As shown, where the encapsulating material thickness value ranges between the intersection of the tensile strength and the isotropic pressure, and the tensile strength and the anisotropic pressure (i.e., about 0.03 mm to about 0.046 mm) represents the optimal encapsulating material thickness. At such a thickness, the encapsulating material would survive injection pressure but release the treatment fluid additive at higher pressures (e.g., fracture closure pressures).

For example, the selected target release profile may be based on a pressure-driven degradation, or a target anisotropic pressure that is greater than both an injection anisotropic pressure and an injection isotropic pressure (thus surviving injection into a subterranean formation). In such instances, cellulose acetate butyrate can be selected as the encapsulating material. A cellulose acetate butyrate coating of a selected thickness on a particle of a selected diameter will remain intact at pressures in the order of about 500 pounds per square inch (psi) and higher, but begins to crack at pressures approaching about 1000 psi (e.g., about 1000 psi of anisotropic pressure). The exact crack pressure to release the treatment fluid additive in an encapsulated additive depends on a number of factors, such as the thickness of the encapsulating material, the percentage of the treatment fluid additive outer surface that is encapsulated (i.e., is it partially or wholly encapsulated), and the like. In other embodiments, a low molecular weight poly(methyl methacrylate) (PMMA) is suitable for an encapsulating material that has a pressure-driven value or target anisotropic pressure target release profile, where the molecular weight of the PMMA is less than 50000.

Further, the encapsulating materials having a target release profile that is based on a pressure-driven profile or an anisotropic target pressure may be manipulated to influence the pressure at which the encapsulating material cracks or is otherwise compromised to release the treatment fluid additive. For example, the encapsulating material can be designed to have “defects” that decrease the pressure at which the encapsulating material cracks. In such cases, in some embodiments, particulates (either hard or soft in form) are embedded in the encapsulating material to decrease the pressure at which failure occurs. In another example, the encapsulating material is designed to have cracks or void space when it is at least partially coated about a treatment fluid additive(s) to decrease the pressure at which it fails (e.g., a low molecular weight PMMA with cracks). In yet another example, the encapsulating material is designed to increase the pressure at which it fails (e.g., to withstand injection pressures). In such cases, the encapsulating material is designed with the addition of plasticizers (e.g., polyvinyl chloride, dioctyl maleate, dioctylphtalate, and the like) or toughening agents (e.g., fibers, resin, rubber, and the like) to the encapsulating material. These various “defects” (e.g., cracks or voids) or substances (e.g., hard or soft particulates, plasticizers, or toughening agents) may be included in the encapsulating material either during its formation, during the process of coating the encapsulating material at least partially about the treatment fluid additive(s), or after the encapsulating material has been coated at least partially about the treatment fluid additive(s) if it remains amendable (e.g., malleable or adhesive) to allow inclusion at such time.

When the target release profile selected is based on an erosion number, encapsulating materials with high erosion numbers are preferred as they degrade by surface erosion rather than dissolution, swelling, or diffusion of the same encapsulating material in contact with a reference fluid (e.g., fresh water). Encapsulating materials that demonstrate predominately (>50%) surface erosion are preferred because surface erosion is characterized by layered erosion, where the outer surface of the material erodes prior to the next inner layer. Surface eroding encapsulating materials do not allow water to penetrate into the material until they have eroded to the final layer. An example of a suitable encapsulating material having a high erosion number include, but are not limited to, polyanhydrides, polyphosphazenes, poly(anhydride-esters), and any combination thereof. Table 1 below demonstrates the erosion number of these encapsulating materials, as compared to a few degradable polymers that have a much lower erosion number and would result in bulk erosion rather than surface erosion. That is, the higher erosion number encapsulating materials have a faster degradation front than diffusion front.

TABLE 1

| Material | Erosion Number |
|---|---|
| Polyesters | 10⁻⁴ |
| Polyamides | 10⁻⁶ |
| Polyketals | 0.001-0.01 |
| Polyanhydrides | 50-200 |
| Polyphosphazenes | 0.1-10 |
| Poly(anhydride-esters) | ~5 |

In some embodiments, the target release profile is based on a combination of temperature-driven degradation and pressure-driven degradation. For example, the encapsulating material may be selected such that it has a target release profile based on high-temperature and high-pressure degradation encountered in a wellbore environment. Materials that would exhibit such profiles would have a glass transition temperature similar that of the temperature of the formation and a temperature dependent Young's modulus such that the “low-temperature” value is sufficient to keep the coating intact during transport until the Young's Modulus value is decreased sufficiently such that the coating becomes compromised upon exposure to the formation temperature and pressure.

In yet other embodiments, the target release profile is based on either amphiphilic water dispersibility or amphiphilic oil dispersibility, where hydrophilic or hydrophobic interactions, respectively, cause removal of the encapsulating material and release of the treatment fluid additive. In such cases, certain amphiphilic polymers can be selected as the encapsulating material to allow dispersibility in water or oil environments (e.g., wellbore environments) based on the target release profile. Examples of such amphiphilic polymers include block copolymers, such as polyacrylic acid-polyacrylate copolymers.

In still other embodiments, the target release profile is based on chemical flood degradation, where a chemical is contacted with the encapsulated additive to trigger degradation of the encapsulating material to release the treatment fluid additive (e.g., in a wellbore environment). The chemical may be introduced into a subterranean formation (e.g., in a treatment fluid) and contacted with the encapsulated additive to trigger degradation. For example, in some embodiments where the target release profile is based on chemical flood degradation, the selected encapsulating material is guar gum and the chemical flood is a breaker, such as borate compounds with or without enzymes able to act on the guar gum.

The encapsulated additives of the present disclosure are sized based on the specific subterranean formation operation with which the treatment fluid additive(s) are to be used and the thickness of the encapsulating material, and may be any size suitable for use in a subterranean formation operation, for example. In some embodiments, the unit mesh size of the encapsulated additives is from about 250 μm to about 5000 μm, encompassing any value and subset therebetween.

As discussed above, the encapsulated additives described herein can be introduced into a subterranean formation in a treatment fluid. The treatment fluid may be comprised of any base fluid suitable for use in a subterranean formation and compatible with the encapsulated additive. The base fluid may be selected to react with the encapsulating material to release the treatment fluid additive either quickly or slowly over time, or may be reactively inert with the encapsulated additive, depending on the particular subterranean formation operation. Suitable base fluids include, but are not limited to, an aqueous base fluid (e.g., fresh water, brine, seawater, and the like), an oil base fluid, an aqueous-miscible (i.e., having an alcohol) base fluid, an oil-in-water emulsion, or a water-in-oil emulsion.

In some embodiments, the selected treatment fluid additive (TFA) is an explosive particle. An encapsulated additive comprising an explosive particle TFA can be used to characterize fractures at low cost and with accuracy, because the characterization takes place downhole and is not subject to interference by surface activities or prior downhole activities. Fracture characterization (e.g., fracture length, height, azimuth, asymmetries, and the like) is significant in subterranean formation operations (e.g., stimulation and production operations) as it is important for correctly placed fractures, complete fractures, mitigation of formation damage, avoidance of costs due to unnecessary fractures, and the like. The explosive particle TFA can directly image, or “illuminate,” fractures that can be delivered into a fracture, such as with proppant, in an unreacted form and then explode therein to produce an acoustic signal. The reaction of the explosive particle TFA is delayed because it is encapsulated in the encapsulating material(s) of the present disclosure based on a desired target release profile. The acoustic signal, in conjunction with existing sensor technology, permits precise or substantially precise characterization of the fracture, such as for use in subsurface imaging.

An encapsulated additive comprising an explosive particle TFA is formed by encapsulating the explosive particle TFA with an encapsulating material (e.g., a polymer). The explosive particle TFA may be encapsulated using a fluidized bed process, such as a Wurster process. The encapsulated additive comprising the explosive particle TFA has a unit mesh size described above and may preferably be placed into a downhole environment (e.g, a fracture) with proppant particulates and thus is sized to mimic the size of the proppant particulates. For example, in some embodiments, during a hydraulic fracturing operation, the encapsulated additives comprising the explosive particle TFA are mixed with typical proppant particulates (e.g., acid-washed sand) at a concentration of about 0.01% to about 1% weight per weight and pumped downhole in a fracturing treatment fluid, encompassing any value and subset therebetween.

As an example, the encapsulating material selected for forming the encapsulated additives comprising explosive particle TFA(s) is designed to have a target release profile of a target anisotropic value, such that the encapsulating material cracks at a particular downhole pressure, but not at the anisotropic and isotropic pressures encountered during injection, as described above. In such cases, the encapsulating material does not crack and can prevent water ingress as it travels from the surface to a particular fracture. Once placed within the fracture, the hydraulic pressure is removed and the anisotropic pressure due to closure stress during shut-in encountered by the encapsulating material (i.e., the target release profile designed based on the particular subterranean formation) causes it to crack and release (or expose) the explosive particle TFA.

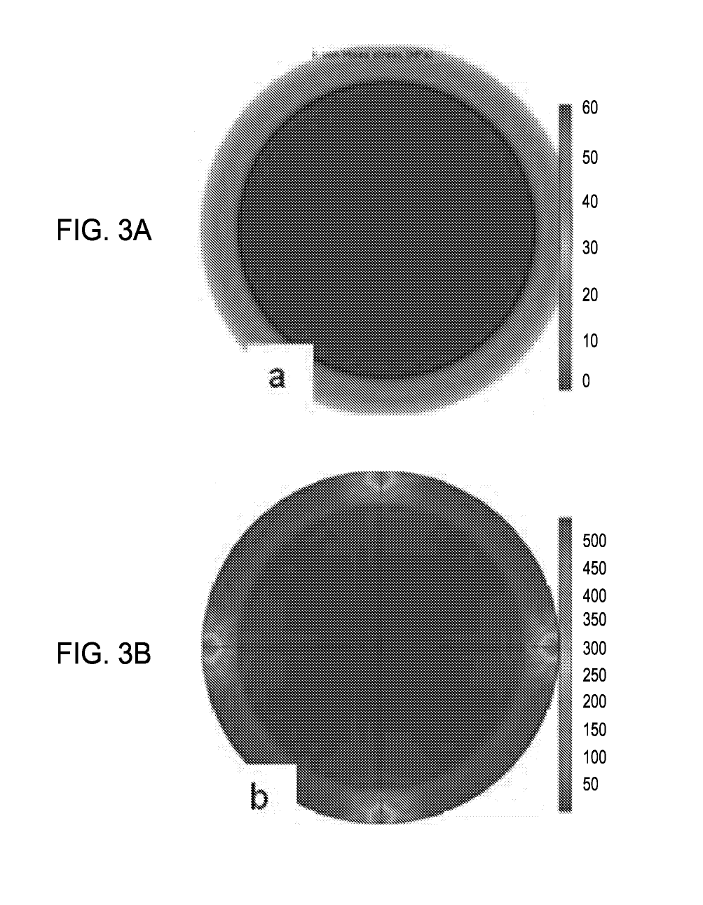

Referring now to FIGS. 3A and 3B, illustrated is an example of the pressure that would be experienced by a spherical encapsulated additive (e.g., the encapsulated additive comprising an explosive particle TFA) in a wellbore environment. FIG. 3A illustrates the isotropic pressure experienced by the spherical encapsulated additive during injection; FIG. 3B illustrates the anisotropic pressure experienced by the spherical encapsulated additive during (and after) closure stress of shut-in. As can be seen, the isotropic pressure experienced during injection (FIG. 3A) is evenly distributed throughout the outer surface of the encapsulated additive, whereas the anisotropic pressure experienced during (and after) shut in (FIG. 3B) is at discrete portions on the outer surface of the encapsulated additive.

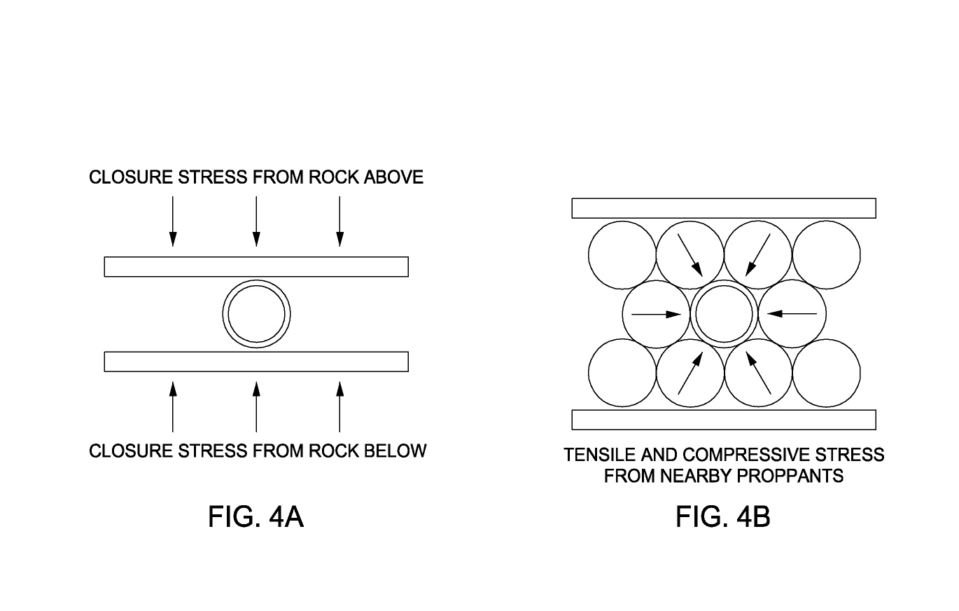

In another view, FIGS. 4A and 4B again illustrate the pressure experienced by a spherical encapsulated additive (e.g., the encapsulated additive comprising an explosive particle TFA) in a wellbore environment. FIG. 4A shows the anisotropic pressure experienced during fracture closure from the surrounding formation; FIG. 4B shows the pressure experienced during (and after) fracture closure from surrounding proppant particulates, manifested as tensile and compressive stress.

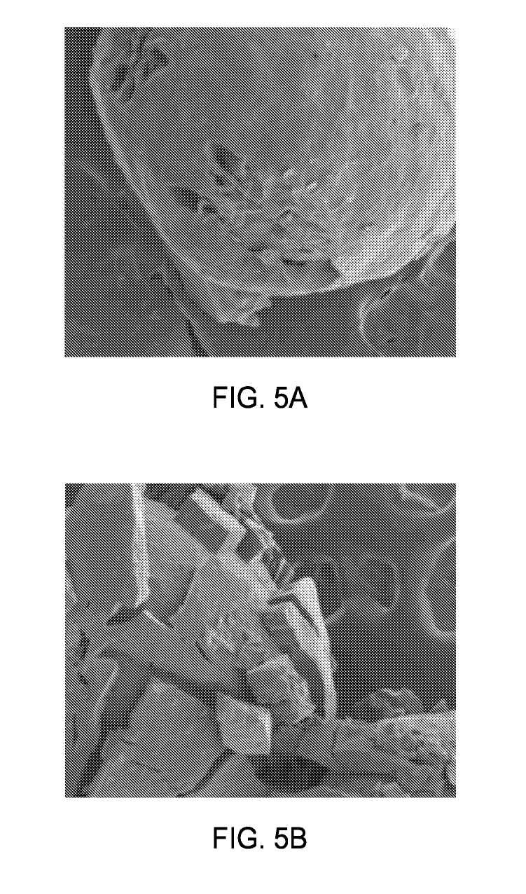

In yet another view, FIGS. 5A-5B is an SEM image of a spherical encapsulated additive encapsulated in an cellulose acetate butyrate encapsulating material being crushed under anisotropic stresses of 1500 psi (FIG. 5A) and 5000 psi (FIG. 5B). As can be seen in FIG. 5A, only small divots are made in the encapsulating material, and thus if the target anisotropic pressure for this encapsulated additive is 1500 psi, a slow release of the treatment fluid additive would be desired. On the other hand, as seen in FIG. 5B, large portions of the encapsulating material is removed or being removed from the encapsulated additive, and thus if the target anisotropic pressure for this encapsulated additive is 5000 psi, a fast release of the treatment fluid additive would be desired.

After experiencing the shut-in pressure, the explosive particle TFA is released from the encapsulating material, depending on its composition, contacts an aqueous fluid (e.g., from the fracturing treatment fluid, or a later flood fluid) to react the explosive particle TFA and create an acoustic signal. The acoustic signal created by a released explosive particle TFA can be detected from an array of accelerometers or geophone sensors at a surface location, in the fractured subterranean formation (e.g., in the wellbore), or in a nearby subterranean formation wellbore. The triangulation of the explosive acoustic signal with the array of sensors determines the location inside the fracture that the encapsulated additives comprising the explosive particle TFA(s) prior to releasing the explosive particle TFA from the encapsulating material, thereby permitting fracture characterization. In some cases, multiple encapsulating additives are placed in the fracture and the acoustic signals together further provides an estimate of the dimensions of the fracture, as well as its location. Moreover, depending on the density differential between the proppant particulates and the encapsulated additives comprising the explosive particle TFA(s), the proppant can be placed at the top, the bottom, or uniformly within the fracture to further elucidate the dimensions and location of the fracture.

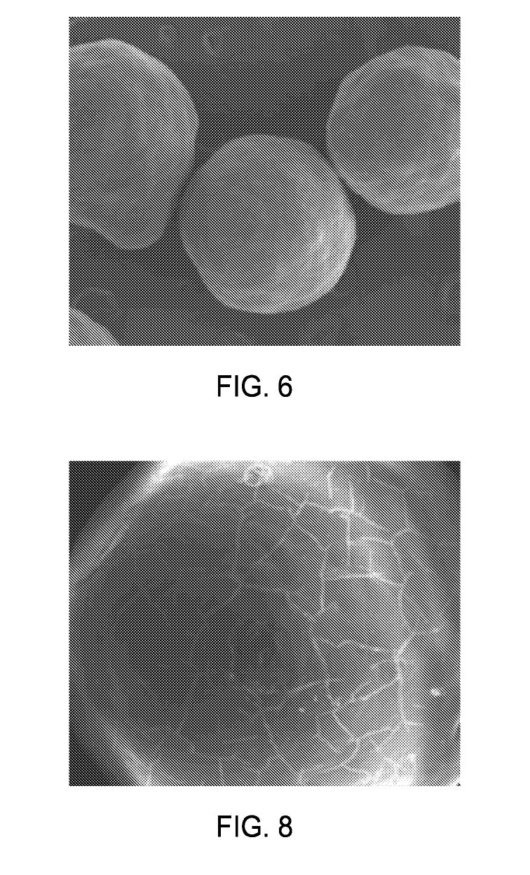

As a specific example of the present disclosure, an explosive particle TFA is composed of a material comprising silver and magnesium nitrate. The explosive particle TFA is 16/20 U.S. Standard Sieve mesh size. The explosive particle TFAs are coated by a Wurster process in a fluidized bed reactor using a 5% cellulose acetate butyrate solution in acetone to form a thick coating of about 50 μm. In some embodiments, as shown in the SEM image of FIG. 6, the encapsulation is substantially free of defects, as described above, with no observed cracks or voids. It is to be appreciated, however, that defects or other target release alteration compounds, as described above, may be included in the encapsulating material for forming the encapsulating additives, without departing from the scope of the present disclosure.

As another specific example, the explosive particle TFA is composed of a stoichiometric mixture of magnesium and ceric ammonium nitrate having an initial diameter of about 0.4 mm and sieved through a 40/60 U.S. Standard Sieve mesh. The explosive particle TFAs are coated by a Wurster process in a fluidized bed reactor using a 5% by weight poly(isobutylmethacrylate) solution in acetone, with 0.75% by weight of dioctylphtalate plasticizer. The thickness of the encapsulating material is about 25 μm and, in some embodiments, substantially free of defects, as described above, with no observed cracks or voids. It is to be appreciated, however, that defects or other target release alteration compounds, as described above, may be included in the encapsulating material for forming the encapsulating additives, without departing from the scope of the present disclosure.

In yet another specific example, the explosive particle TFA is composed of a material comprising magnesium and iodine having an initial diameter of 0.6 mm and sieved through a 20/40 U.S. Standard Sieve mesh. The explosive particle TFAs are coated by a Wurster process in a fluidized bed reactor using 5% by weight poly(bis-ethoxyphosphazene) solution in tetrahydrofuran. The thickness of the encapsulating material is about 100 μm and, in some embodiments, substantially free of defects, as described above, with no observed cracks or voids. It is to be appreciated, however, that defects or other target release alteration compounds, as described above, may be included in the encapsulating material for forming the encapsulating additives, without departing from the scope of the present disclosure.

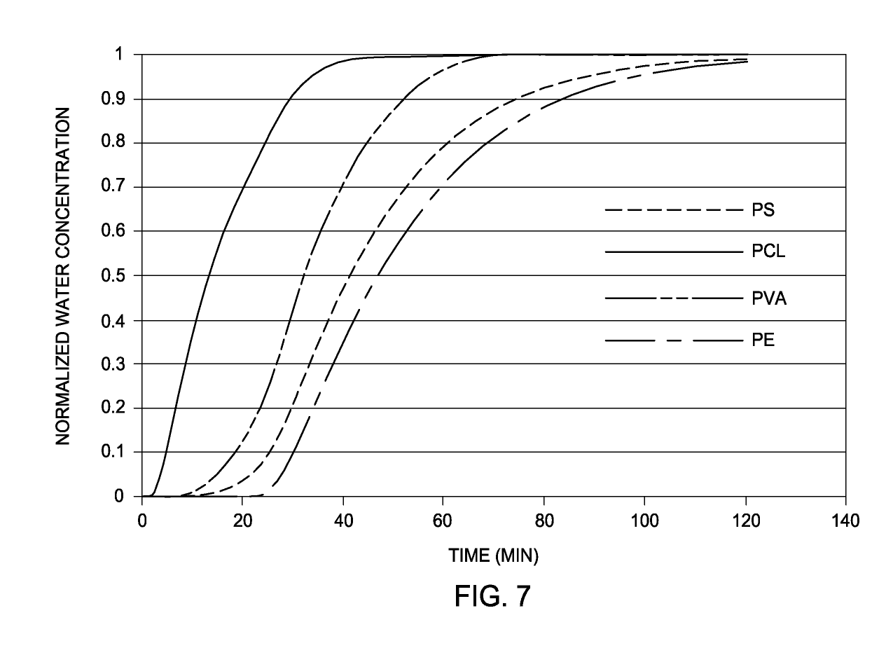

It is to be appreciated that although the above examples related to encapsulated additives comprising explosive particle TFA(s) describe the use of an encapsulating material whose target release profile is based on a target anisotropic pressure, other encapsulating materials that have other target release profiles may be selected, without departing from the scope of the present disclosure. As an example, the encapsulating material may be selected to have a target release profile based on a water ingress value. That is, the explosive particle TFA is selected to be reactive upon contact with water and the encapsulating agent is selected to allow water ingress over time such that the explosive particle TFA is released (and reactive) over a particular time. For example, the encapsulating material selected for a water ingress value may be, among others, a polystyrene, a polycaprolactone, a polyvinylacetate, or a polyethylene based on a water ingress value, represented in FIG. 7 as a normalized water concentration that diffuses through the encapsulating material over time in minutes (min). As shown, the polycaprolactone encapsulating material comparatively permits the greatest concentration of water ingress in the least amount of time, whereas the polyethylene encapsulating material comparatively permits the least concentration of water ingress in the same amount of time.

In some embodiments, the treatment fluid additive selected for forming the encapsulated additives of the present disclosure is a lubricant. Such lubricants may be used, for example, in wellbore drilling operations, where they reduce the contact frictional forces between the drill pipe, drill bit, bottom-hole assembly, and the formation, among other things. The lubricant TFAs are particularly important at reducing such contact frictional forces when drilling horizontal or deviated (i.e., angular) wellbores. Examples of lubricant TFAs include, but are not limited to, diesel (which may be dissolved in a solid matrix, paraffin wax, polyalphaolefins, glass beads, and the like, and any combination thereof. The “solid matrix” is a liquid dispersed within a solid that is a homogenous mixture (dissolved phase is <1 nm) or colloid (dispersed phase is <1 μm). The encapsulating material at least partially encapsulating the lubricant TFAs can be achieved by a Wurster process in a fluidized bed processor, or another process without departing from the scope of the present disclosure.

The encapsulated additives described herein utilizing an encapsulating material to encapsulate such lubricants and prevent or reduce their interaction with other additives present in a drilling fluid, which can influence rheology or reactivity of such additives. Additionally, the encapsulated additives can prevent or reduce a lubricant TFAs propensity to coat or lose volume to the drill string during transport to the drill bit, thereby ensuring optimum rate of penetration thereat. That is, the encapsulating material at least partially encapsulating the lubricant TFAs prevents its interaction with drilling fluid additives and prevents its volume from being spent prior to its desired reactive location downhole.

When the selected treatment fluid additive is a lubricant TFA, the encapsulated additive comprising the lubricant TFA(s) can be used in a drilling operation. The encapsulated additive can be added to the drilling fluid at a hopper and then directly placed into circulation during drilling. The encapsulating material selected is preferably insoluble or substantially insoluble in the base fluid comprising the drilling fluid and prevents the interaction of the lubricant TFA(s) with the drilling fluid. However, upon contact high shear or impact, for example, the encapsulating material is cracked or otherwise compromised to release the lubricant TFA(s). For example, the material forming the encapsulating material is frangible (brittle) and breaks or cracks upon impingement on the formation, shear in the drill bit, shear between the drill bit and the formation, and the like, and any combination thereof. An example of a suitable frangible encapsulating material is polystyrene.

As described herein, the treatment fluid additive may be a biocide. During hydraulic fracturing operations, the combination of the high surface area of the formation and the presence of water-based fracturing fluids can lead to the growth of biofilms on the formation surface, which can be either or both of aerobic and/or anaerobic bacteria (such as sulfur reducing bacteria). The biocide TFAs are used to prevent such bacterial growth, which can pose health and safety concerns as well as require specialized personnel during injection of the fracturing fluid. The encapsulated additives described herein allow the biocide TFAs to be introduced into a treatment fluid without being immediately reacted with other additives present in the fracturing fluid causing the biocide TFA to lose its effectiveness before reaching deep regions of the formation or of fractures therein. Suitable biocides for use as the biocide TFA at least partially encapsulated in the encapsulating materials described herein may be any biocide suitable for use in a subterranean formation. Examples of suitable biocides include, but are not limited to, hypochlorite bleach, cyanuric acids (e.g., trichloroisocyanuric acid), halogenated salts (e.g., lithium hypochlorite, peroxide based compounds), and the like, and any combination thereof.

As described herein, solid biocide TFA particles are coated with an encapsulating material to achieve a particular target release profile (e.g., by a particular coating thickness, by selecting particular encapsulating material type(s), and the like). As such, the release of the biocide TFA can be controlled during an entire fracturing operation, even allowing certain biocide TFAs to be released earlier than others from the encapsulating material. As a specific example, a biocide TFA is coated by a Wurster process in a fluidized bed reactor with a PMMA encapsulating material designed to have micro-crack “defects,” as shown in the SEM image of FIG. 8, which span from the outer surface of the encapsulating material to the inner surface of the encapsulating material at least partially surrounding the biocide TFA to form the encapsulated additive. It is to be appreciated, however, that micro-cracks or larger cracks may be superficially formed on the outer surface of the encapsulating material only, without departing from the scope of the present disclosure. The presence of the micro-crack defects, as seen in FIG. 8, essentially creates a permeable encapsulation at least partially about the biocide TFA that allows the diffusion of fluids (e.g., water) through the encapsulating material, resulting in dissolution of the solid biocide TFA and subsequent release of the biocide TFA through the micro-cracks and into the surrounding fracturing fluid. By controlling the thickness of the encapsulating material and the dimensions of the micro-cracks, the release rate of the biocide TFA is controlled.

In some embodiments, the treatment fluid additive is a hydrogen sulfide scavenger. Hydrogen sulfide, which may be present in a formation reservoir or generated inside process systems and/or the wellbore by sulfur reducing bacteria, is a hazardous chemical that can be produced with oil and gas to the surface, causing safety concerns to operators. The hydrogen sulfide scavenger TFAs of the present disclosure can be any compound that can react with hydrogen sulfide to convert it into a less or non-hazardous form, such as a metal oxide, a metal carbonate, a metal hydroxide, and the like, and any combination thereof. Examples of suitable hydrogen sulfide scavenger TFAs for use in the embodiments of the present disclosure include, but are not limited to, zinc oxide, zinc carbonate, iron hydroxide, and the like, and any combination thereof. The encapsulated additives comprising the hydrogen sulfide scavenger TFA(s) are encapsulated in an encapsulating material to prevent their agglomeration (which reduces their exposed surface area for reaction, and can influence fluid rheology) and their becoming spent (reacting) with other additives in a treatment fluid.

In preferred embodiments, the hydrogen sulfide scavenger TFAs are nanoparticles that have a high surface area, as defined herein, for maximum reaction with hydrogen sulfide to react therewith and form other sulfur compounds and remove the hydrogen sulfide. For example, the hydrogen sulfide scavenger TFAs may have a size in the range of about 5 nm to about 100 nm, encompassing any value and subset therebetween. The individual nanoparticulate hydrogen sulfide scavenger TFAs can be initially agglomerated into larger particles using a binder, such as a water-soluble binder (e.g., ethylcellulose). The agglomerated particles are used to form the encapsulated additive. In some embodiments, the target release profile for the encapsulated additive comprising the hydrogen sulfide scavenger TFA is based on a chemical flood degradation or a target anisotropic pressure. When the target release profile is based on a chemical flood degradation, the selected encapsulating material can be water-insoluble and degradable by an acid, such as a polysebacic acid. When the target release profile is based on a target anisotropic pressure, the selected encapsulating material can be frangible and crack upon contact with the target anisotropic pressure, such as polystyrene. Upon releasing the hydrogen sulfide scavenger TFAs in agglomerated form, the binder is dissolved or otherwise degraded to expose the individual nanoparticulate hydrogen sulfide scavenger TFAs.

It is to be appreciated that the various examples of treatment fluid additives and encapsulating materials are non-limiting and each can be used in any combination with other treatment fluid additives and encapsulating materials, depending on the desired release profile, without departing from the scope of the present disclosure.

In various embodiments, systems configured for delivering a treatment fluid comprising encapsulated additives described herein to a downhole location are described, such as during a hydraulic fracturing operation. In various embodiments, the systems can comprise a pump fluidly coupled to a tubular, the tubular containing a treatment fluid comprising the encapsulated additives, referred to below simply as “treatment fluid.”

The pump may be a high-pressure pump in some embodiments. As used herein, the term “high pressure pump” will refer to a pump that is capable of delivering a fluid downhole at a pressure of about 1000 psi or greater. A high-pressure pump may be used when it is desired to introduce the treatment fluid to a subterranean formation at or above a fracture gradient of the subterranean formation, but it may also be used in cases where fracturing is not desired. In some embodiments, the high-pressure pump may be capable of fluidly conveying particulate matter, such as the encapsulated additives, into the subterranean formation. Suitable high-pressure pumps will be known to one having ordinary skill in the art and may include, but are not limited to, floating piston pumps and positive displacement pumps.

In other embodiments, the pump may be a low-pressure pump. As used herein, the term “low pressure pump” will refer to a pump that operates at a pressure of about 1000 psi or less. In some embodiments, a low-pressure pump may be fluidly coupled to a high-pressure pump that is fluidly coupled to the tubular. That is, in such embodiments, the low-pressure pump may be configured to convey the treatment fluid to the high-pressure pump. In such embodiments, the low-pressure pump may “step up” the pressure of the treatment fluid before it reaches the high-pressure pump.

In some embodiments, the systems described herein can further comprise a mixing tank that is upstream of the pump and in which the treatment fluid is formulated. In various embodiments, the pump (e.g., a low-pressure pump, a high-pressure pump, or a combination thereof) may convey the treatment fluid from the mixing tank or other source of the treatment fluid to the tubular. In other embodiments, however, the treatment fluid can be formulated offsite and transported to a worksite, in which case the treatment fluid may be introduced to the tubular via the pump directly from its shipping container (e.g., a truck, a railcar, a barge, or the like) or from a transport pipeline. In either case, the treatment fluid may be drawn into the pump, elevated to an appropriate pressure, and then introduced into the tubular for delivery downhole.

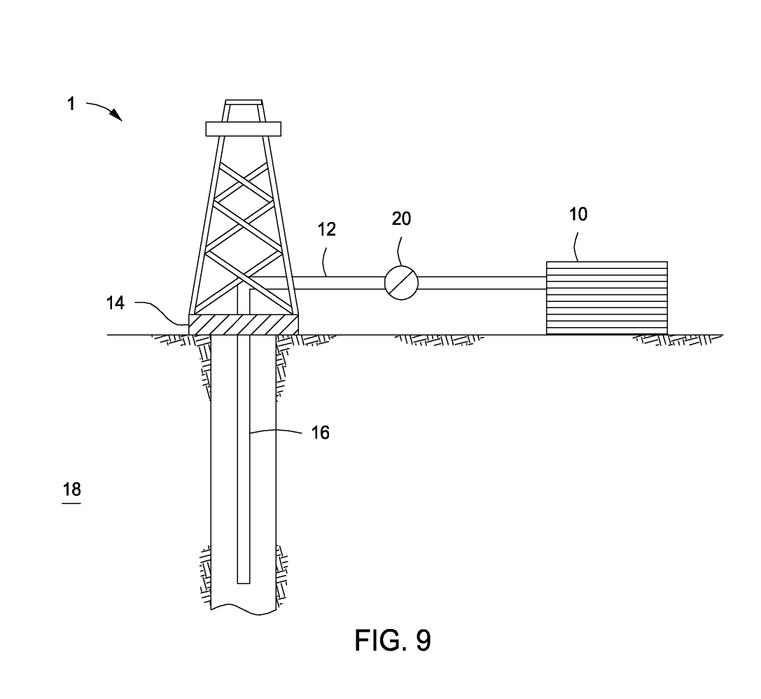

FIG. 9 shows an illustrative schematic of a system that can deliver treatment fluids of the present disclosure to a downhole location, according to one or more embodiments. It should be noted that while FIG. 9 generally depicts a land-based system, it is to be recognized that like systems may be operated in subsea locations as well. As depicted in FIG. 9, system 1 may include mixing tank 10, in which a treatment fluid of the present disclosure may be formulated. The treatment fluid may be conveyed via line 12 to wellhead 14, where the treatment fluid enters tubular 16, tubular 16 extending from wellhead 14 into subterranean formation 18. Upon being ejected from tubular 16, the treatment fluid may subsequently penetrate into subterranean formation 18. In some instances, tubular 16 may have a plurality of orifices (not shown) through which the treatment fluid of the present disclosure may enter the wellbore proximal to a portion of the subterranean formation 18 to be treated. In some instances, the wellbore may further comprise equipment or tools (not shown) for zonal isolation of a portion of the subterranean formation 18 to be treated.

Pump 20 may be configured to raise the pressure of the treatment fluid to a desired degree before its introduction into tubular 16. It is to be recognized that system 1 is merely exemplary in nature and various additional components may be present that have not necessarily been depicted in FIG. 9 in the interest of clarity. Non-limiting additional components that may be present include, but are not limited to, supply hoppers, valves, condensers, adapters, joints, gauges, sensors, compressors, pressure controllers, pressure sensors, flow rate controllers, flow rate sensors, temperature sensors, and the like.

Although not depicted in FIG. 9, the treatment fluid may, in some embodiments, flow back to wellhead 14 and exit subterranean formation 18. In some embodiments, the treatment fluid that has flowed back to wellhead 14 may subsequently be recovered and recirculated to subterranean formation 18. In other embodiments, the treatment fluid may be recovered and used in a different subterranean formation, a different operation, or a different industrial application.

It is also to be recognized that the disclosed treatment fluids may also directly or indirectly affect the various downhole equipment and tools that may come into contact with the treatment fluids during operation. Such equipment and tools may include, but are not limited to, wellbore casing, wellbore liner, completion string, insert strings, drill string, coiled tubing, slickline, wireline, drill pipe, drill collars, mud motors, downhole motors and/or pumps, surface-mounted motors and/or pumps, centralizers, turbolizers, scratchers, floats (e.g., shoes, collars, valves, etc.), logging tools and related telemetry equipment, actuators (e.g., electromechanical devices, hydromechanical devices, etc.), sliding sleeves, production sleeves, plugs, screens, filters, flow control devices (e.g., inflow control devices, autonomous inflow control devices, outflow control devices, etc.), couplings (e.g., electro-hydraulic wet connect, dry connect, inductive coupler, etc.), control lines (e.g., electrical, fiber optic, hydraulic, etc.), surveillance lines, drill bits and reamers, sensors or distributed sensors, downhole heat exchangers, valves and corresponding actuation devices, tool seals, packers, cement plugs, bridge plugs, and other wellbore isolation devices, or components, and the like. Any of these components may be included in the systems generally described above and depicted in FIG. 9.

Embodiments disclosed herein include:

### Embodiment A

A composition comprising: an encapsulated additive comprising a treatment fluid additive at least partially encapsulated by an encapsulating material, wherein the encapsulated additive has a target release profile for release of the treatment fluid additive from the encapsulating material in a specific wellbore environment, and wherein the encapsulating material is selected to achieve the target release profile, the target release profile being based on one or more conditions selected from the group consisting of: (1) a target anisotropic pressure that is greater than both an injection anisotropic pressure and an injection isotropic pressure, (2) an erosion number, (3) a temperature-driven degradation, (4) a pressure-driven degradation, (5) an amphiphilic water dispersibility, (6) an amphiphilic oil dispersibility, (7) a chemical flood degradation, (8) a water ingress value, and, (9) a radiation-driven degradation.

### Embodiment B

A method comprising: introducing an encapsulated additive into a subterranean formation, the encapsulated additive comprising a treatment fluid additive at least partially encapsulated by an encapsulating material, wherein the encapsulated additive has a target release profile for release of the treatment fluid additive from the encapsulating material in a specific wellbore environment, and wherein the encapsulating material is selected to achieve the target release profile, the target release profile being based on one or more conditions selected from the group consisting of: (1) a target anisotropic pressure that is greater than both an injection anisotropic pressure and an injection isotropic pressure, (2) an erosion number, (3) a temperature-driven degradation, (4) a pressure-driven degradation, (5) an amphiphilic water dispersibility, (6) an amphiphilic oil dispersibility, (7) a chemical flood degradation, (8) a water ingress value, and, (9) a radiation-driven degradation.

### Embodiment C

A method comprising: designing an encapsulated additive comprising a treatment fluid additive at least partially encapsulated by an encapsulating material, wherein the encapsulated additive has a target release profile for release of the treatment fluid additive from the encapsulating material in a specific wellbore environment; selecting the encapsulating material to achieve the target release profile, the target release profile being based on one or more conditions selected from the group consisting of: (1) a target anisotropic pressure that is greater than both an injection anisotropic pressure and an injection isotropic pressure, (2) an erosion number, (3) a temperature-driven degradation, (4) a pressure-driven degradation, (5) an amphiphilic water dispersibility, (6) an amphiphilic oil dispersibility, (7) a chemical flood degradation, (8) a water ingress value, and, (9) a radiation-driven degradation; introducing the encapsulated additive into a subterranean formation; and releasing the treatment fluid additive from the encapsulating material in the subterranean formation based on the target release profile.

Embodiments A, B, and C may have one or more of the following additional elements in any combination:

Element 1: Wherein a plurality of treatment fluid additives are agglomerated with a binder prior to encapsulation with the encapsulating material.

Element 2: Wherein a thickness of the encapsulating material is selected to achieve the target release profile.

Element 3: Wherein the encapsulating material is selected based on an erosion number of the encapsulating material such that the encapsulating material demonstrates predominately surface erosion.

Element 4: Wherein the treatment fluid additive is an explosive particulate, a lubricant, a biocide, a hydrogen sulfide scavenger, a breaker, a proppant, an oxygen scavenger, and any combination thereof.

Element 5: Wherein the treatment fluid additive is in liquid form and is adsorbed onto a surface of a high surface area particle, and the encapsulating material encapsulates the high surface area particle having the treatment fluid additive adsorbed thereon.

Element 6: Wherein the encapsulating material is selected from the group consisting of a polyester, a polyanhydride, a polyamide, a polyketal, a polyphosphazene, a poly(anhydride ester), a polyacrylic acid, a polyacrylate, a polyacrylic acid-polyacrylate copolymer, and any combination thereof.

Element 7: Wherein the encapsulating material is selected from the group consisting of cellulose acetate butyrate, poly(isobutylmethacrylate), poly(bis-ethoxyphosphazene), polystyrene, poly(methyl methacrylate), polycaprolactone, polyvinylacetate, polyethylene, polyethylene, polyethyleneimine, polyethylene glycol, polyethyleneimine-polyethylene glycol co-polymer, guar gum, and any combination thereof.

Element 8: Wherein the encapsulated material is spray coated about an outer surface of the treatment fluid additive.

Element 9: Further comprising spray coating the encapsulated material about an outer surface of the treatment fluid additive.

Element 10: Wherein the encapsulated additive is in a treatment fluid.

Element 11: Wherein the encapsulated additive is in a treatment fluid, and further comprising introducing the encapsulated additive into the subterranean formation in a treatment fluid.

Element 12: Further comprising a tubular extending into the subterranean formation and a pump fluidically coupled to the tubular, the tubular containing the encapsulated additive.

By way of non-limiting example, exemplary combinations applicable to A, B, C include: 1-12; 1, 2, and 11; 2, 6, and 8; 5 and 9; 2, 7, 8, 9, and 12; 1 and 10; 9 and 12; 4, 5, and 8; 3, 4, and 7; and the like.

Therefore, the present disclosure is well adapted to attain the ends and advantages mentioned as well as those that are inherent therein. The particular embodiments disclosed above are illustrative only, as they may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present disclosure. The embodiments illustratively disclosed herein suitably may be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces.

What is claimed is:

1. A composition comprising:
an encapsulated additive comprising a treatment fluid additive at least partially encapsulated by an encapsulating material,
wherein the encapsulated additive has a target release profile for release of the treatment fluid additive from the encapsulating material in a specific wellbore environment, and
wherein the encapsulating material is selected to achieve the target release profile, the target release profile being based on one or more conditions selected from the group consisting of:
(1) a target anisotropic pressure that is greater than both an injection anisotropic pressure and an injection isotropic pressure,
(2) an erosion number,
(3) a temperature-driven degradation,
(4) a pressure-driven degradation,
(5) an amphiphilic water dispersibility,
(6) an amphiphilic oil dispersibility,
(7) a chemical flood degradation,
(8) a water ingress value, and,
(9) a radiation-driven degradation.

2. The composition of claim 1, wherein a plurality of treatment fluid additives are agglomerated with a binder prior to encapsulation with the encapsulating material.

3. The composition of claim 1, wherein a thickness of the encapsulating material is selected to achieve the target release profile.

4. The composition of claim 1, wherein the encapsulating material is selected based on an erosion number of the encapsulating material such that the encapsulating material demonstrates predominately surface erosion.

5. The composition of claim 1, wherein the treatment fluid additive is an explosive particulate, a lubricant, a biocide, a hydrogen sulfide scavenger, a breaker, a proppant, an oxygen scavenger, and any combination thereof.

6. The composition of claim 1, wherein the treatment fluid additive is in liquid form and is adsorbed onto a surface of a high surface area particle, and the encapsulating material encapsulates the high surface area particle having the treatment fluid additive adsorbed thereon.

7. The composition of claim 1, wherein the encapsulating material is selected from the group consisting of a polyester, a polyanhydride, a polyamide, a polyketal, a polyphosphazene, a poly(anhydride ester), a polyacrylic acid, a polyacrylate, a polyacrylic acid-polyacrylate copolymer, and any combination thereof.

8. The composition of claim 1, wherein the encapsulating material is selected from the group consisting of cellulose acetate butyrate, poly(isobutylmethacrylate), poly(bis-ethoxyphosphazene), polystyrene, poly(methyl methacrylate), polycaprolactone, polyvinylacetate, polyethylene, polyethylene, polyethyleneimine, polyethylene glycol, polyethyleneimine-polyethylene glycol co-polymer, guar gum, and any combination thereof.

9. The composition of claim 1, wherein the encapsulated material is spray coated about an outer surface of the treatment fluid additive.

10. The composition of claim 1, wherein the encapsulated additive is in a treatment fluid.

11. A method comprising:
introducing an encapsulated additive into a subterranean formation, the encapsulated additive comprising a treatment fluid additive at least partially encapsulated by an encapsulating material,
wherein the encapsulated additive has a target release profile for release of the treatment fluid additive from the encapsulating material in a specific wellbore environment, and
wherein the encapsulating material is selected to achieve the target release profile, the target release profile being based on one or more conditions selected from the group consisting of:
(1) a target anisotropic pressure that is greater than both an injection anisotropic pressure and an injection isotropic pressure,
(2) an erosion number,
(3) a temperature-driven degradation,
(4) a pressure-driven degradation,
(5) an amphiphilic water dispersibility,
(6) an amphiphilic oil dispersibility,
(7) a chemical flood degradation,
(8) a water ingress value, and,
(9) a radiation-driven degradation.

12. The method of claim 11, further comprising introducing the encapsulated additive into the subterranean formation in a treatment fluid.

13. The method of claim 11, wherein the treatment fluid additive is an explosive particulate, a lubricant, a biocide, a hydrogen sulfide scavenger, a breaker, a proppant, an oxygen scavenger, and any combination thereof.

14. The method of claim 11, further comprising spray coating the encapsulated material about an outer surface of the treatment fluid additive.

15. The method of claim 11, further comprising a tubular extending into the subterranean formation and a pump fluidically coupled to the tubular, the tubular containing the encapsulated additive.

16. A method comprising:
designing an encapsulated additive comprising a treatment fluid additive at least partially encapsulated by an encapsulating material,
wherein the encapsulated additive has a target release profile for release of the treatment fluid additive from the encapsulating material in a specific wellbore environment;
selecting the encapsulating material to achieve the target release profile, the target release profile being based on one or more conditions selected from the group consisting of:
(1) a target anisotropic pressure that is greater than both an injection anisotropic pressure and an injection isotropic pressure,
(2) an erosion number,
(3) a temperature-driven degradation,
(4) a pressure-driven degradation,
(5) an amphiphilic water dispersibility,
(6) an amphiphilic oil dispersibility,
(7) a chemical flood degradation,
(8) a water ingress value, and,
(9) a radiation-driven degradation;
introducing the encapsulated additive into a subterranean formation; and
releasing the treatment fluid additive from the encapsulating material in the subterranean formation based on the target release profile.

17. The method of claim 16, further comprising introducing the encapsulated additive into the subterranean formation in a treatment fluid.

18. The method of claim 16, wherein the treatment fluid additive is an explosive particulate, a lubricant, a biocide, a hydrogen sulfide scavenger, a breaker, a proppant, an oxygen scavenger, and any combination thereof.

19. The method of claim 16, further comprising spray coating the encapsulated material about an outer surface of the treatment fluid additive.

20. The method of claim 16, further comprising a tubular extending into the subterranean formation and a pump fluidically coupled to the tubular, the tubular containing the encapsulated additive.
